(19) United States
(12) Patent Application Publication
(10) Pub. No.: US 2010/0052578 A1
(43) Pub. Date: Mar. 4, 2010

(54) SUBMINIATURE LINEAR VIBRATOR

(75) Inventor: Jung-Hoon Kim, Daegu (KR)

Correspondence Address: BIRCH STEWART KOLASCH & BIRCH, PO BOX 747, FALLS CHURCH, VA, 22040-0747, US

(73) Assignee: J&J Corp., Iksan-si (KR)

(21) Appl. No.: 12/514,842

(22) PCT Filed: Nov. 6, 2007
(86) PCT No.: PCT/KR07/05583

§ 371 Date: Jun. 12, 2009

(30) Foreign Application Priority Data
Nov. 15, 2006 (KR) 10-2006-0112546
Jan. 16, 2007 (KR) 10-2007-0004919

(51) Int. Cl. H02P 7/285; H02K 33/00

(52) U.S. Cl. 318/114; 310/25

(57) ABSTRACT

Disclosed is a subminiature linear vibrator including a stationary body (100) formed by installing a printed circuit board (10), on which a ring-shaped field coil (12), at least one resonant passive element (14), and a frequency generating control chip (16) are mounted, on a lower case (6) of a main body, the main body including upper and lower cases (4, 6); and a movable body (200) formed by mounting a ring-shaped balance weight (22) and a ring-shaped permanent magnet (24) on the lower surface of a bracket (20) having an air flow hole (21) formed therethrough and connecting an elastic spring (26) to the lower surface of the upper case (4) and an air flow hole peripheral portion (20a) of the bracket (20), wherein the ring-shaped permanent magnet (24), magnetized with two poles vertically located at upper and lower portions thereof, is disposed adjacent to the ring-shaped field coil (12).

### TECHNICAL FIELD

The present invention relates to a vibrator, and more particularly to a vibrator, which has a subminiature size and is linearly vibrated.

### BACKGROUND ART

Recently, as mobile stations have been greatly reduced in size, various parts employed in the correspondent mobile stations are reduced in size and thickness. The parts requiring reduction in size and thickness include a vibrator for vibration and alarm of a cellular phone. Mostly, this vibrator assumes the form of a subminiaturized vibration motor.

As an example of the subminiaturized vibration motor, Korean Patent Utility Model Application No. 20-2001-0037688 discloses a flat noncommutator vibration motor, filed Dec. 6, 2001 by the applicant of the present invention (also, PCT publication No. WO 03/049255 A1).

The above flat vibration noncommutator vibration motor is a coin-type vibration motor, the thickness, weight, and the size of which are highly reduced, and a brushless-type vibration motor without brushes and a commutator. An eccentric portion (balance weight) is disposed on one side of the peripheral surface of a rotor made of a permanent magnet, and one or more pairs of hall sensors for sensing poles of the permanent magnet or the positions of the poles are mounted in the vibration motor so as to start and drive the vibration motor. A motor controller is installed in the internal space of the vibration motor, and the arrangement of a stator coil is improved so as to reduce the loss of magnetic flux as well as remove the non-operation points.

The above flat vibration motor is a subminiature vibrator having a thickness of 2˜3 mm and a diameter less than 15 mm. If this subminiature vibrator is embodied by another method other than the above-described motor method, the subminiature vibrator may be embodied by various methods.

### DISCLOSURE

### Technical Problem

Therefore, the present invention has been made in view of the above problems, and it is an object of the present invention to provide a vibrator, which has a subminiature size and is linearly vibrated.

It is another object of the present invention to provide a subminiature linear vibrator including a coil resonance frequency generating unit.

### Technical Solution

In accordance with an aspect of the present invention, the above and other objects can be accomplished by the provision of a subminiature linear vibrator comprising a stationary body formed by installing a printed circuit board, on which a ring-shaped field coil, at least one resonant passive element, and a frequency generating control chip are mounted, on a lower case of a main body, the main body including upper and lower cases; and a movable body formed by mounting a ring-shaped balance weight and a ring-shaped permanent magnet on the lower surface of a bracket having an air flow hole formed therethrough and connecting an elastic spring to the lower surface of the upper case and an air flow hole peripheral portion of the bracket, wherein the ring-shaped permanent magnet, magnetized with two poles vertically located at upper and lower portions thereof, is disposed adjacent to the ring-shaped field coil.

### ADVANTAGEOUS EFFECTS

The subminiature linear vibrator of the present invention has a subminiature size and is linearly vibrated, and includes a resonance frequency generator installed therein, thus not requiring a separate circuit unit installed at the outside of the main body of the vibrator.

### DESCRIPTION OF DRAWINGS

The above and other objects, features and other advantages of the present invention will be more clearly understood from the following detailed description taken in conjunction with the accompanying drawings, in which:

FIG. 1 is an exploded perspective view of a subminiature linear vibrator in accordance with an embodiment of the present invention;

FIG. 2 is a longitudinal sectional view of the subminiature linear vibrator in accordance with the embodiment of the present invention;

FIG. 3 is a transversal sectional view of FIG. 2;

FIG. 4 is a circuit diagram of the subminiature linear vibrator in accordance with the embodiment of the present invention;

FIGS. 5A to 5C are views illustrating the vibrating principle of the subminiature linear vibrator in accordance with the embodiment of the present invention;

FIG. 6 is an enlarged perspective view of an elastic spring of FIG. 1;

FIG. 7 is a graph illustrating the wave form of a resonance frequency signal of FIG. 4;

FIG. 8 is a longitudinal sectional view of a subminiature linear vibrator in accordance with another embodiment of the present invention;

FIG. 9 is a circuit diagram of the subminiature linear vibrator of FIG. 8;

FIGS. 10A to 10C are views illustrating the vibrating principle of the subminiature linear vibrator of FIG. 8;

FIG. 11 is a graph illustrating the wave form of a resonance frequency signal of FIG. 9;

FIG. 12 is a longitudinal sectional view of a modification of the subminiature linear vibrator of FIG. 2; and

FIG. 13 is an exploded perspective view of another modification of the subminiature linear vibrator of the present invention.

### BEST MODE

In the term ‘subminiature linear vibrator’ of the present invention, the term ‘linear vibrator’ means a device which is vibrated by the linear movement of a movable body, differing from a motor-type vibrator which is vibrated by the rotation of a rotor. Further, the term ‘subminiature’ means that a main body of the linear vibrator preferably has a thickness 2˜5 mm and a diameter of 7˜20 mm.

Hereinafter, preferred embodiments of the present invention will be described in detail with reference to the annexed drawings.

In a subminiature linear vibrator in accordance with the present invention, a movable body moves vertically linearly, differing from a motor-type vibrator, in which the rotation of a rotor generates vibration. Thus, when the subminiature linear vibrator of the present invention is installed in a mobile station, the subminiature linear vibrator has a relatively large vibration amount, sensed by a user, and a relatively high response speed, compared with the motor-type vibrator.

Further, in the subminiature linear vibrator in accordance with the present invention, a coil resonance frequency generating unit is installed in a subminiature main body. Here, the coil resonance frequency generated from the coil resonance frequency generating unit is varied according to a plurality of parameters for vibrating the linear vibrator. In the present invention, the coil resonance frequency generating unit includes a frequency generating control chip (IC) and resonant passive elements (capacitors or resistances), and properly generates a required resonance frequency by regulating a capacitance value using the capacitors.

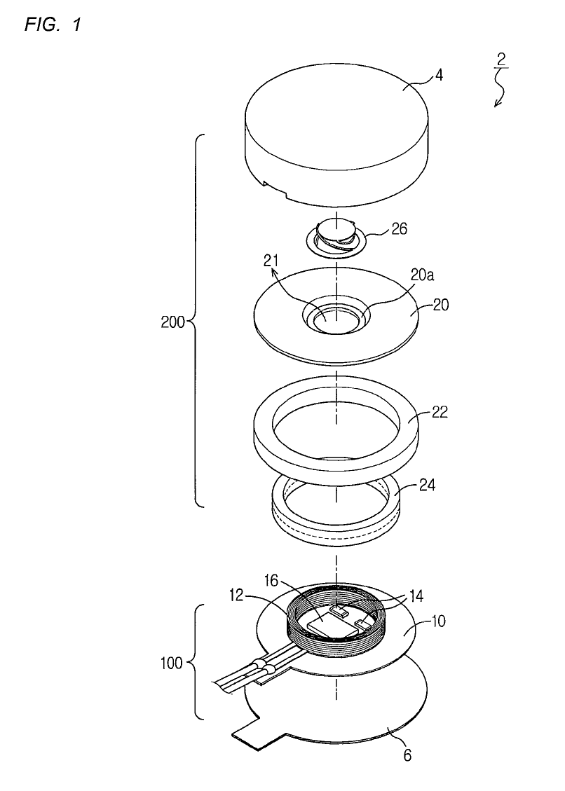

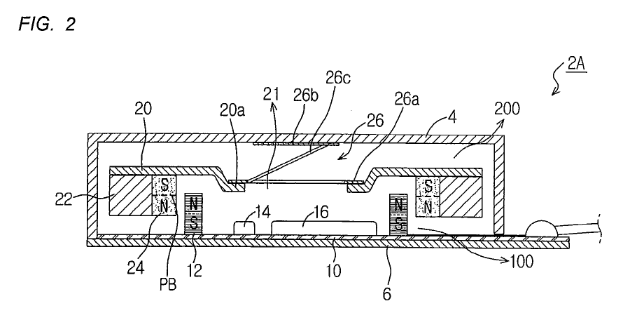

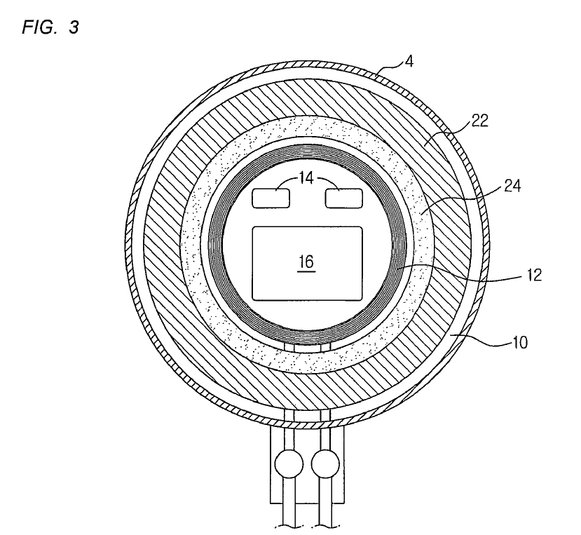

FIG. 1 is an exploded perspective view of a subminiature linear vibrator 2 in accordance with an embodiment of the present invention. FIG. 2 is a longitudinal sectional view of the subminiature linear vibrator 2 in accordance with the embodiment of the present invention. FIG. 3 is a transversal sectional view of FIG. 2. FIG. 4 is a circuit diagram of the subminiature linear vibrator 2 in accordance with the embodiment of the present invention.

The subminiature linear vibrator 2 in accordance with this embodiment of the present invention forms a main body by connecting an upper case 4 and a lower case 6. The subminiature linear vibrator 2 is manufactured such that the main body has a subminiature size with a thickness of 2˜5 mm and a diameter of 7˜20 mm.

A printed circuit board 10, on which a ring-shaped field coil 12, resonant passive elements 14, and a frequency generating control chip 16 are mounted, is installed on the lower case 6, thus forming a stationary body 100.

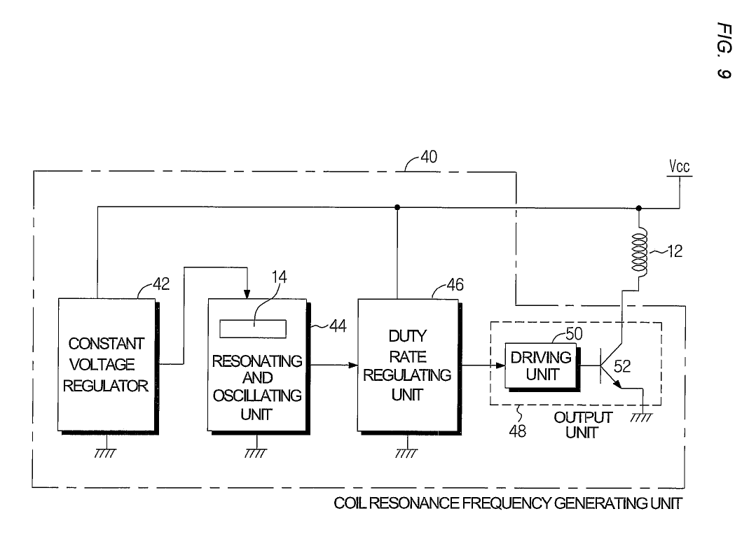

Preferably, the ring-shaped field coil 12 has a designated diameter and is disposed on the printed circuit board 10 in a concentric circular shape. The resonant passive elements 14, such as capacitors or resistances, and the frequency generating control chip 16 are disposed on the printed circuit board 10 within the ring-shaped field coil 12. The resonant passive elements 14 and the frequency generating control chip 16 form a coil resonance frequency generating unit (40 of FIG. 4), which generates the resonance frequency of the ring-shaped field coil 12. The frequency generating control chip 16 can generate a resonance frequency, required by a designer, by regulating a capacitance value using capacitors or a resistance value using resistances as an example of the resonant passive elements 14. Preferably, multilayer chip capacitors or multilayer ceramic capacitors (MLCCs) having a subminiature size are used as the capacitors as an example of the resonant passive elements 14. The coil resonance frequency generating unit 40 will be described later in detail with reference to FIGS. 4 and 9.

A movable body 200, which linearly moves due to an interaction with the stationary body 100 of the lower case 2, is formed on the upper case 4. That is, a ring-shaped balance weight 22 and a ring-shaped permanent magnet 24 are mounted the lower surface of a bracket 20 having an air flow hole 21 formed therethrough, and an elastic spring 26 is connected to the lower surface of the upper case 4 and an air flow hole peripheral portion 20a of the bracket 20, thus forming the movable body 200.

The ring-shaped balance weight 22 mounted on the lower surface of the bracket 20 is made of a material having a large specific gravity, such as tungsten, and serves as a weight of the movable body 200. Here, the ring-shaped balance weight 22 is mounted on the outermost portion of the lower surface of the bracket 20. The ring-shaped permanent magnet 24, magnetized with two poles vertically located at upper and lower portions thereof, is mounted on the lower surface of the bracket 20 such that the ring-shaped permanent magnet 24 is disposed adjacent to the inner circumferential surface of the ring-shaped balance weight 22.

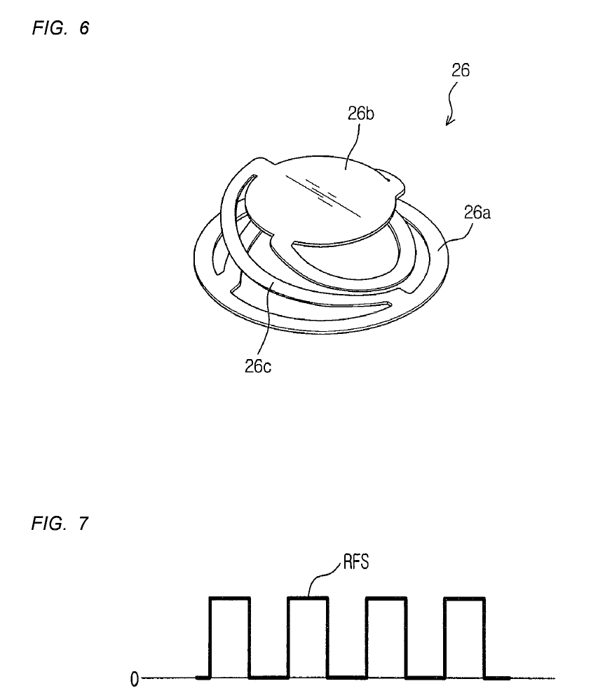

The air flow hole 21 of the bracket 20 allows an air current, generated by the linear reciprocation of the movable body 22 in the vertical direction, to smoothly flow. The air flow hole peripheral portion 20a of the bracket 20 is bent into a concave shape. As shown in FIG. 6, a lower ring piece 26a of the elastic spring 26 is fused onto the air flow hole peripheral portion 20a of the basket 20 by spot welding or laser welding, and an upper piece 26b of the elastic spring 26 is fused onto the lower surface of the upper case 4 by spot welding or laser welding.

In FIG. 6, non-described reference numeral “26c” is an elastically supporting connection portion of the elastic spring 26.

As shown in FIG. 6, the upper piece 26b of the elastic spring 26 has a diameter smaller than the inner diameter of the lower ring piece 26a of the elastic spring 26. This structure of the elastic spring 26 allows a worker to first fix the lower ring piece 26a of the elastic spring 26 to the upper surface of the air flow hole peripheral portion 20a of the bracket 20 by spot welding or laser welding and then to easily fix the upper piece 26b of the elastic spring 26 to the lower surface of the upper case 4 using a welding machine put into the air flow hole 21 of the bracket 20.

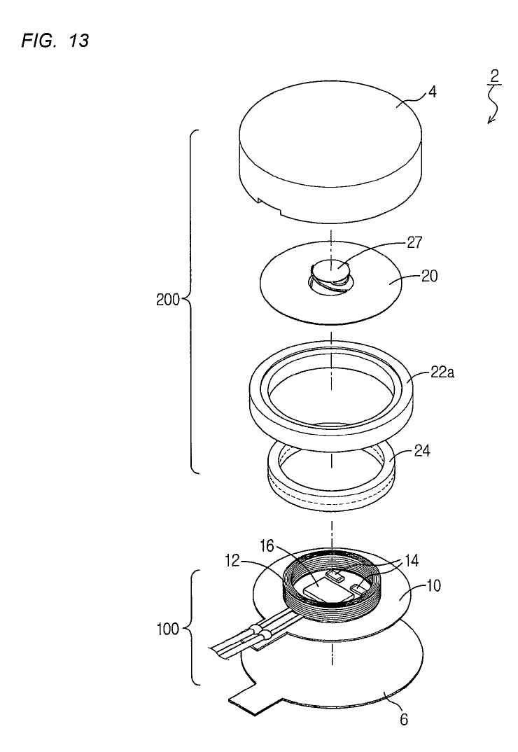

The elastic spring 26 and the bracket 20, as shown in FIG. 1, are separately manufactured and then are connected by spot welding or laser welding. However, in accordance with a modified embodiment, as shown in FIG. 13, the elastic spring 27 is integrated with the bracket 20. In the case that the elastic spring 27 is integrated with the bracket 20, as shown in FIG. 13, the bracket 20 of FIG. 13 has a thickness smaller than the total thickness of the bracket 20 of FIG. 1 (by approximately 0.2˜0.3 mm), and has a flat surface without a concave structure for welding to the elastic spring 27.

Further, since the integrated bracket 20 having the elastic spring 27, shown in FIG. 13, is inserted into a fixing groove of a ring-shaped balance weight 22a and fixed to the ring-shaped balance weight 22a by welding or using an adhesive agent, the ring-shaped balance weight 22a in FIG. 13 has the same diameter of the ring-shaped balance weight 22 of FIG. 1, but has a weight heavier than the weight of the ring-shaped balance weight 22 of FIG. 1. The reason is that the body of the ring-shaped balance weight 22a is protruded upwardly as long as the height of a protrusion for forming the fixing groove. However, the ring-shaped balance weight 22 of FIG. 1 may be modified such that a fixing groove is formed in the balance weight 22 and the bracket 20 is inserted into the fixing groove.

In the present invention, the ring-shaped permanent magnet 24, magnetized with two poles vertically located at upper and lower portions thereof, of the movable body 200 is disposed adjacent to the ring-shaped field coil 12 of the stationary body 100, as shown in FIGS. 2, 8, and 12.

In FIG. 2, an arrangement 2A of the ring-shaped field coil 12 of the stationary body 100 and the ring-shaped permanent magnet 24 of the movable body 200 is configured such that a pole boundary PB of the ring-shaped permanent magnet 24 is lower than the uppermost end of the ring-shaped field coil 12 in the initial state.

More specifically with reference to FIG. 2, in the case that the S and N poles are vertically located at the upper and lower portions of the permanent magnet 24, the pole boundary PB of the ring-shaped permanent magnet 24 is disposed adjacent to the upper N pole out of the N and S poles (magnetic poles) of the ring-shaped field coil 12. That is, in the embodiment of the present invention, as shown in FIG. 2, the ring-shaped permanent magnet 24 is configured such that the S and N poles are vertically located at the upper and lower portions of the permanent magnet 24, and the ring-shaped field coil 12 is configured such that the N and S poles are vertically located at the upper and lower portions of the ring-shaped field coil 12, contrary to the two poles of the ring-shaped permanent magnet 24.

Due to the arrangement 2A of the ring-shaped permanent magnet 24 and the ring-shaped field coil 12, the lower N pole of the ring-shaped permanent magnet 24 is affected by the attraction of the lower S pole (field pole) of the ring-shaped field coil 12, and the upper S pole of the ring-shaped permanent magnet 24 is affected by the attraction of the upper N pole (field pole) of the ring-shaped field coil 12. Thereby, the movable body 200 moves down.

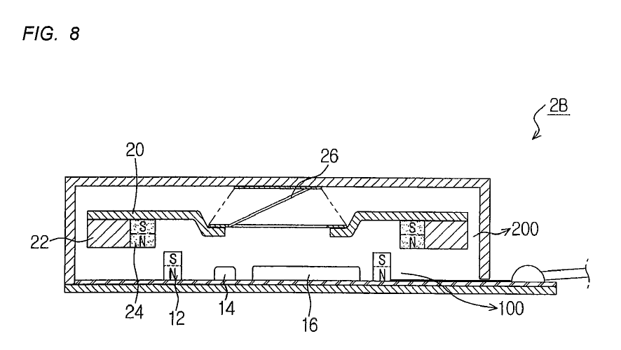

On the other hand, in FIG. 8, an arrangement 2B of the ring-shaped field coil 12 of the stationary body 100 and the ring-shaped permanent magnet 24 of the movable body 200 is configured such that the ring-shaped permanent magnet 24 of the movable body 200 is located at a portion adjacent to the upper end of the ring-shaped field coil 12 of the stationary body 100 in the initial state. In the subminiature linear vibrator 2 in accordance with another embodiment of the present invention, as shown in FIG. 8, the N and S poles are alternately formed on the ring-shaped field coil 12, and thus the movable body 200 vertically reciprocates.

FIG. 12 illustrates an arrangement 2C, which is modified from the arrangement 2A of FIG. 2. The arrangement 2C, as shown in FIG. 12, is configured such that the ring-shaped field coil 12 of the stationary body 100 is inserted into a separation space, formed between the ring-shaped permanent magnet 24 and the ring-shaped balance weight 22 of the movable body 200, and moves up and down in the separation space.

Although the arrangement 2C of FIG. 12 is a modification of the arrangement 2A of the subminiature linear vibrator 2 of FIG. 2, those skilled in the art will appreciate that the arrangement 2C of FIG. 12 may be modified from the arrangement 2B of the subminiature linear vibrator 2 of FIG. 8.

Preferably, the lower case 6 of the subminiature linear vibrator 2 of the present invention is made of a magnetic substance, such as an iron plate, so as to increase the electromagnetic force of the ring-shaped field coil 12 and shield the leakage of the electromagnetic force to the outside. If necessary, the lower case 6 may be made of a nonmagnetic substance or a diamagnetic substance. Further, preferably, the bracket 20 is made of a magnetic substance, such as an iron plate, so as to increase the magnetic force of the ring-shaped permanent magnet 24 and shield the leakage of the magnetic force through the upper portion of the bracket 20. The upper case 4 is made of either a nonmagnetic substance or a diamagnetic substance.

In the subminiature linear vibrator 2 having the arrangement 2A of FIG. 2 in accordance with one embodiment, the movable body 200 moves up and down due to the attraction between the ring-shaped field coil 12 of the stationary body 100 and the ring-shaped permanent magnet 24 of the movable body 200 and the elasticity of the elastic spring 26 of the movable body 200. Here, the movable body 200 resonates and oscillates up and down using the coil resonance frequency generating unit 40 of FIG. 4, and thus the subminiature linear vibrator 2 is linearly vibrated.

With reference to FIG. 4, the coil resonance frequency generating unit 40 includes a constant voltage regulator 42, a resonating and oscillating unit 44 having the resonant passive elements 14, a duty rate regulating unit 46, and an output unit 48 including a driving unit 50, and applies a drive current, corresponding to a resonance frequency for resonating and oscillating the movable body 200, to the ring-shaped field coil 12.

The constant voltage regulator 42, an internal circuit element unit of the resonating and oscillating unit 44, the duty rate regulating unit 46, and the driving unit 50 of the coil resonance frequency generating unit 40, are embodied in an IC form, like the frequency generating control chip 16, as shown in FIGS. 1 to 3.

However, resonant passive elements of the resonating and oscillating unit 44, such as RC circuits or LC circuits, of the coil resonance frequency generating unit 40 are at least one resonant passive element 14, as shown in FIGS. 1 to 3, and are disposed separately from the frequency generating control chip 16.

The reason why the resonant passive element 14 is disposed separately from the frequency generating control chip 16 is that the resonance frequency generated by the coil resonance frequency generating unit 40 has a value set in consideration of parameters, such as the intensity of the magnetic force of the ring-shaped permanent magnet 24 of the movable body 200, the intensity of the electromagnetic force generated by the drive current flowing along the ring-shaped field coil 12 of the stationary body 100, the weight of the ring-shaped balance weight 22, and the elastic modulus of the elastic spring 26. Thus, when the parameters are set, the value of the resonance frequency of the coil resonance frequency generating unit 40 is obtained. Accordingly, a designer may mount at least one resonant passive element 14, such as at least one capacitor having a capacitance value for producing the obtained resonance frequency or at least one resistance having a resistance value for producing the obtained resonance frequency, on the printed circuit board 10.

In the case that the capacitor composition of the resonating and oscillating unit 44 is contained in an IC, such as the frequency generating control chip 16, the capacitance value is fixed and thus the resonance frequency required by the correspondent linear vibrator cannot be produced.

Hereinafter, with reference to FIG. 4, the operation for generating a resonance frequency in the coil resonance frequency generating unit 40 and outputting a drive current corresponding to the resonance frequency will be described in more detail.

When constant voltage generated from the constant voltage regulator 42 of the coil resonance frequency generating unit 40 is applied to the resonating and oscillating unit 44, the resonating and oscillating unit 44 generates a constant oscillating frequency. The resonating and oscillating unit 44 performs oscillation by means of an RC time constant or an LC time constant. Here, when the resonating and oscillating unit 44 is embodied into an RC circuit, the capacitor composition in the RC time constant is formed by at least one capacitor, i.e., at least one MLCC.

An oscillating signal generated from the resonating and oscillating unit 44 is set to a frequency for resonating the coil by regulating a capacitance value or a resistance value by a designer using the resonant passive element 14, such as a capacitor or a resistance, and is applied to the duty rate regulating unit 46. The duty rate regulating unit 46 sets a pulse duty rate of the oscillating frequency to 50:50, and applies the set pulse duty rate to the driving unit 50 of the output unit 48 through a resonance frequency signal RFS, as shown in FIG. 7. The driving unit 50 of the output unit 48 applies the binary logic state of a drive pulse, corresponding to the resonance frequency signal RFS, to a drive switching unit 52, such as a transistor. Accordingly, the drive switching unit 52 responds to the binary logic state of the drive pulse, corresponding to the resonance frequency signal RFS, i.e., a ‘high’ state or a ‘low’ state, and thus is turned on, thereby allowing a drive current to flow along the ring-shaped field coil 12.

In accordance with one embodiment of the present invention, in the case that the S and N poles are vertically located at the upper and lower portions of the ring-shaped permanent magnet 24 of the movable body 200, as shown in FIG. 2, the drive current flows along the ring-shaped field coil 12 of the stationary coil 100, and thus the N field pole is formed at the upper portion of the ring-shaped field coil 12 and the S field pole is formed at the lower portion of the ring-shaped field coil 12.

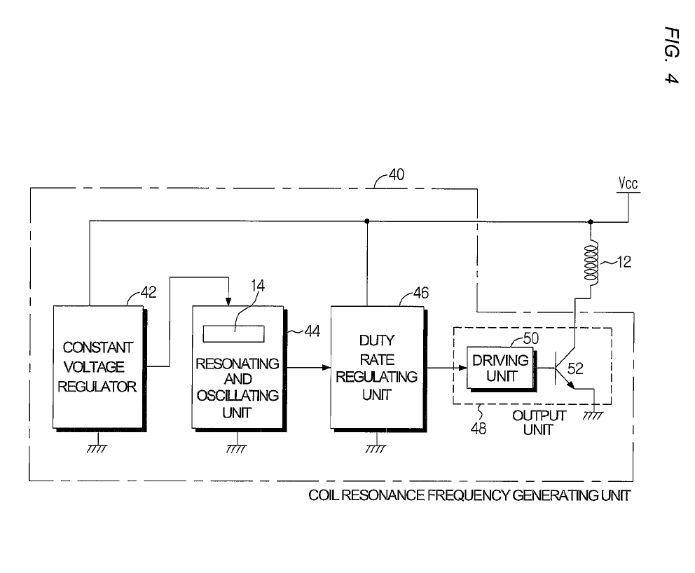

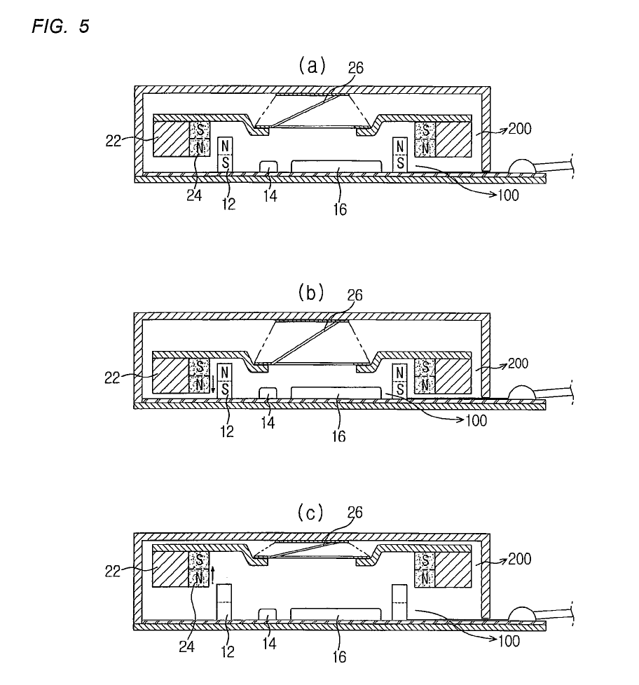

Accordingly, in the initial state in which the drive current does not flow along the ring-shaped field coil 12, the movable body 200 maintains the initial position, as shown in FIG. 5A, and when the drive current flows along the ring-shaped field coil 12, the upper N field pole and the lower S field pole are formed on the ring-shaped field coil 12. Thereby, the movable body 200 moves down, as shown in FIG. 5B. Then, until the movable body 200 moves down to the lowermost position, the drive current does not flow along the ring-shaped field coil 12.

In the above state, the elastic spring 26 connected to the lower surface of the upper case 4 is extended and thus has the maximal elastic restoring force, as shown in FIG. 5B. Then, the movable body 200 moves up from the lowermost position to the uppermost position due to the elastic restoring force of the elastic spring 26, as shown in FIG. 5C.

Thereafter, the movable body 200 is restored to its initial position, as shown in FIG. 5A, due to the compressing force of the elastic spring 26. When the movable body 200 is restored to its initial position, the drive current flows again along the ring-shaped field coil 12 of the stationary body 100. Thereby, the process of FIGS. 5A to 5C is continuously repeated.

As described above, a resonating and oscillating operation is achieved by the interaction between the stationary body 100 and the movable body 200, and thus the linear vibrator 2 of the present invention is linearly vibrated.

In the subminiature linear vibrator 2 having the arrangement 2B, as shown in FIG. 8, in accordance with another embodiment of the present invention, the N and S poles are alternately formed on the ring-shaped field coil 12 of the stationary body 100, and thus the movable body 200 linearly reciprocates in the vertical direction. Here, the movable body 200 is resonated and oscillated vertically using the coil resonance frequency generating unit 40 employed in the main body, as shown in FIG. 9, and thus the subminiature linear vibrator 2 is linearly vibrated.

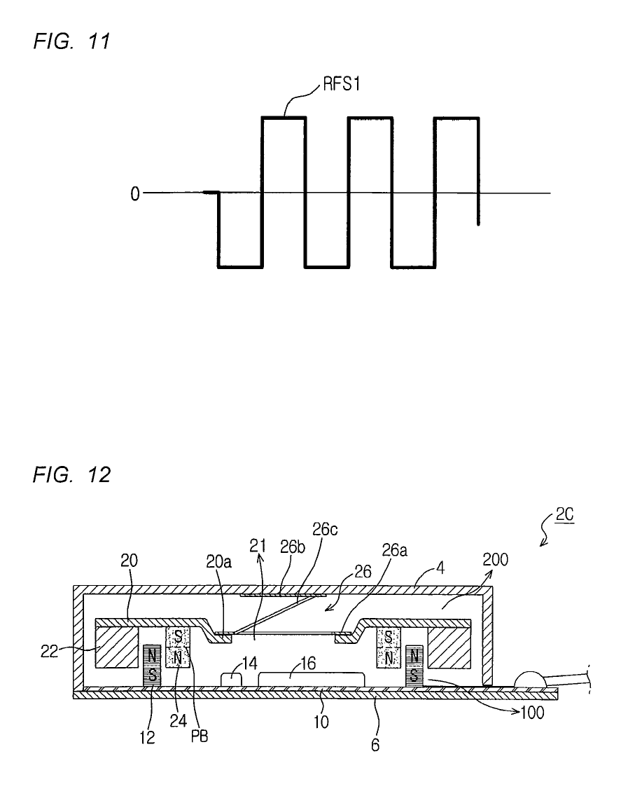

The components of the coil resonance frequency generating unit 40 of FIG. 9 are the same as those of the coil resonance frequency generating unit 40 of FIG. 4 except for the circuit configuration of the output unit 48. The driving unit 50 of the output unit 48 of FIG. 4 is configured such that the driving unit 50 outputs a binary logic signal, corresponding to the resonance frequency signal RFS having a positive (+) pulse, as shown in FIG. 7, to the rear drive switching unit 52, but a driving unit 50a of the output unit 48 of FIG. 9 is configured such that the driving unit 50a outputs a resonance frequency signal RFS1 having positive (+) and negative (−) pulses, as shown in FIG. 11, to a rear drive switching unit 52a. The rear drive switching unit 52a complementarily switches the first and fourth switches SW1 and SW4 and the second and third switches SW2 and SW3 in response to the resonance frequency signal RFS1 of FIG. 11, thereby alternately forming a regular-direction current path and a reverse-direction current path on the ring-shaped field coil 12. The movable body 200 is linearly reciprocated in the vertical direction by the poles due to the regular-direction current path and the reverse-direction current path formed on the ring-shaped field coil 12.

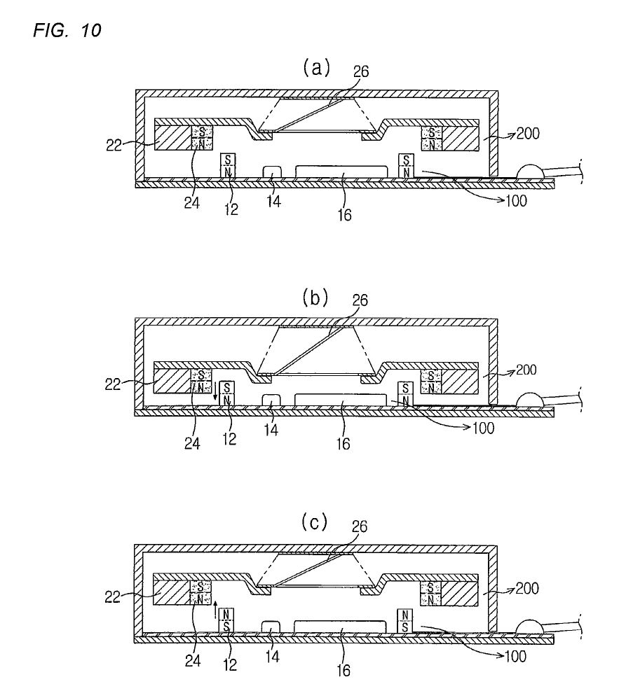

Hereinafter, with reference to FIGS. 10A to 10C, the operating principle of the subminiature linear vibrator 2 having the arrangement 2B of FIG. 8 and the coil resonance frequency generating unit 40 of FIG. 9 will be described in more detail.

In the initial state in which a drive current does not flow along the ring-shaped field coil 12 of the stationary body 200 of FIG. 8, the movable body 200 maintains its initial position adjacent to the upper end of the ring-shaped field coil 12 of the stationary body 100 (FIG. 10A). In this state, when the resonance frequency signal RFS1, i.e., the negative (−) pulse, as shown in FIG. 11, is applied to the drive switching unit 52a of the output unit 48 so as to switch on the second and third switches SW2 and SW3 of the drive switching unit 52a of the output unit 48 and thus the drive current flows along the ring-shaped field coil 12 in the reverse direction, the upper S field pole and the lower N field pole are formed on the ring-shaped field coil 12, as shown in FIG. 10A. Thereby, the movable body 200 moves down to the lower position, which the attractive power of the S field pole of the ring-shaped field coil 12 affects, as shown in FIG. 10B.

Thereafter, the resonance frequency signal RFS1, i.e., the positive (+) pulse, as shown in FIG. 11, is applied to the drive switching unit 52a of the output unit 48 so as to switch on the first and fourth switches SW1 and SW4 of the drive switching unit 52a of the output unit 48 and thus the drive current flows along the ring-shape field coil 12 in the regular direction, the upper N field pole and the lower S field pole are formed on the ring-shaped field coil 12, as shown in FIG. 10C. Thereby, the movable body 200 moves up to the initial position due to the repulsive power of the N field pole of the ring-shaped field coil 12, as shown in FIG. 10C.

The movable body 200 achieves a resonating and oscillating operation by repeating the process of FIGS. 10A to 10C, and thus the linear vibrator 2 of the present invention is linearly vibrated.

### INDUSTRIAL APPLICABILITY

The subminiature linear vibrator of the present invention is used as a vibrating device in a mobile station of a cellular phone or a game machine.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A subminiature linear vibrator comprising:
a stationary body formed by installing a printed circuit board, on which a ring-shaped field coil, at least one resonant passive element, and a frequency generating control chip are mounted, on a lower case of a main body, the main body including upper and lower cases; and
a movable body formed by mounting a ring-shaped balance weight and a ring-shaped permanent magnet on the lower surface of a bracket having an air flow hole formed therethrough and connecting an elastic spring to the lower surface of the upper case and an air flow hole peripheral portion of the bracket,
wherein the ring-shaped permanent magnet, magnetized with two poles vertically located at upper and lower portions thereof, is disposed adjacent to the ring-shaped field coil.

2. The subminiature linear vibrator according to claim 1, wherein the at least one resonant passive element and the frequency generating control chip forms a coil resonance frequency generating unit for generating a coil resonance frequency.

3. The subminiature linear vibrator according to claim 1, wherein the at least one resonant passive element is at least one MLCC, and forms a capacitance composition of an RC oscillating unit.

4. The subminiature linear vibrator according to claim 1, wherein a pole boundary of the ring-shaped permanent magnet is lower than the uppermost end of the ring-shaped field coil.

5. The subminiature linear vibrator according to claim 2, wherein the coil resonance frequency generating unit includes:
a constant voltage regulator generating a constant voltage;
a RC oscillating unit including the at least one resonant passive element and outputting an oscillating signal based on an RC time constant under the supply of the constant voltage;
a duty rate regulating unit regulating the duty rate of the oscillating signal and outputting the regulated duty rate through a resonance frequency signal; and
an outputting unit applying a drive current, based on the resonance frequency signal, to the ring-shaped field coil.

6. The subminiature linear vibrator according to claim 2, wherein the coil resonance frequency generated from the coil resonance frequency generating unit is obtained in consideration of parameters, including the intensity of the magnetic force of the ring-shaped permanent magnet, the intensity of the electromagnetic force generated due to the drive current flowing along the ring-shaped field coil, the weight of the ring-shaped balance weight, and the elastic modulus of the elastic spring.

7. The subminiature linear vibrator according to claim 1, wherein the lower case and the bracket are made of a magnetic substance.

8. The subminiature linear vibrator according to claim 1, wherein the air flow hole peripheral portion of the bracket is bent into a concave shape.

9. The subminiature linear vibrator according to claim 8, wherein the elastic spring includes a lower ring piece, an upper piece, and an elastically supporting connection portion, and the diameter of the upper piece fused onto the lower surface of the upper case is smaller than the inner diameter of the lower ring piece fused onto the air flow hole peripheral portion.

10. The subminiature linear vibrator according to claim 4, wherein the two poles are vertically formed at the upper and lower portions of the ring-shaped permanent magnet, and two field poles are vertically formed at upper and lower portions of the ring-shaped field coil, contrary to the poles of the ring-shaped permanent magnet.

11. A subminiature linear vibrator comprising:
a stationary body formed by installing a printed circuit board, on which a ring-shaped field coil, at least one resonant passive element, and a frequency generating control chip are mounted, on a lower case of a main body, the main body including upper and lower cases; and
a movable body formed by mounting a ring-shaped balance weight and a ring-shaped permanent magnet on the lower surface of a bracket having an air flow hole formed therethrough and connecting an elastic spring to the lower surface of the upper case and an air flow hole peripheral portion of the bracket,
wherein the ring-shaped permanent magnet, magnetized with two poles vertically located at upper and lower portions thereof, is disposed adjacent to the ring-shaped field coil, such that the ring-shaped permanent magnet is located at a portion adjacent to the upper end of the ring-shaped field coil in the initial state.

12. A subminiature linear vibrator comprising:
a stationary body formed by installing a printed circuit board, on which a ring-shaped field coil, at least one resonant passive element, and a frequency generating control chip are mounted, on a lower case of a main body, the main body including upper and lower cases; and
a movable body formed by mounting a ring-shaped balance weight and a ring-shaped permanent magnet on the lower surface of a bracket having an air flow hole formed therethrough and integrated with an elastic spring,
wherein the ring-shaped permanent magnet, magnetized with two poles vertically located at upper and lower portions thereof, is disposed adjacent to the ring-shaped field coil, such that the ring-shaped permanent magnet is located at a portion adjacent to the upper end of the ring-shaped field coil in the initial state.

13. A subminiature linear vibrator comprising:
a stationary body formed by installing a printed circuit board, on which a ring-shaped field coil, at least one resonant passive element, and a frequency generating control chip are mounted, on a lower case of a main body, the main body including upper and lower cases; and
a movable body formed by mounting a ring-shaped balance weight and a ring-shaped permanent magnet on the lower surface of a bracket having an air flow hole formed therethrough and integrated with an elastic spring,
wherein the ring-shaped permanent magnet, magnetized with two poles vertically located at upper and lower portions thereof, is disposed adjacent to the ring-shaped field coil, such that a pole boundary of the ring-shaped permanent magnet is lower than the uppermost end of the ring-shaped field coil in the initial state.

14. The subminiature linear vibrator according to claim 1, wherein the ring-shaped field coil of the stationary body is inserted into a separation space between the ring-shaped permanent magnet and the ring-shaped balance weight of the movable body such that ring-shaped field coil can move up and down in the separation space.
